(19) United States
(12) Patent Application Publication
(10) Pub. No.: US 2017/0351354 A1
(43) Pub. Date: Dec. 7, 2017

(54) DISPLAY PANEL, TOUCH INPUT APPARATUS, SENSING APPARATUS FOR SENSING TOUCH POSITION AND TOUCH PRESSURE FROM DISPLAY PANEL, AND SENSING METHOD

(71) Applicant: HiDeep Inc., Gyeonggi-do (KR)

(72) Inventor: Sang Sic YOON, Gyeonggi-do (KR)

(21) Appl. No.: 15/532,904

(22) PCT Filed: Dec. 4, 2015
(86) PCT No.: PCT/KR2015/013184

§ 371 Date: Jun. 2, 2017

(30) Foreign Application Priority Data
Dec. 5, 2014 (KR) 1020140174269
Dec. 24, 2014 (KR) 1020140188069

(51) Int. Cl. G06F 3/044; G02F 1/1335; G02F 1/1333; G06F 3/041; G02F 1/1343

(52) U.S. Cl. CPC G06F 3/044; G06F 3/0412; G02F 1/13439; G02F 1/13338; G02F 1/134363; G02F 1/133514; G02F 2201/121

(57) ABSTRACT

A display panel capable of sensing a touch pressure may be provided, that includes: a plurality of first electrodes and a plurality of second electrodes which are formed in different layers apart from each other; a plurality of third electrodes formed in the same layer as the layer in which the first electrode is formed; and a reference electrode which is provided between the layer in which the first electrode and the third electrode are formed and the layer in which the second electrode is formed, or provided under the layer in which the first electrode and the third electrode are formed. The plurality of the second electrodes generate a first signal including information on a capacitance which is changed by a touch, and the plurality of the third electrodes generate a second signal including information on a capacitance which is changed by the touch. As a result, it is not necessary to separately provide the touch sensor because the touch position and the touch pressure can be sensed by the display panel. Also, it is possible to simultaneously sense the touch position and the touch pressure instead of to sequentially sense them.

### TECHNICAL FIELD

The present disclosure relates to a display panel capable of sensing a touch position and a touch pressure, a touch input device capable of sensing the touch position and the touch pressure, a detection device detecting the touch position and the touch pressure from the display panel, and a detection method thereof.

### BACKGROUND ART

Various kinds of input devices are being used to operate a computing system. For example, the input device includes a button, key, joystick and touch screen. Since the touch screen is easy and simple to operate, the touch screen is increasingly being used in operation of the computing system.

The touch screen may include a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the display screen by a finger, etc. Generally, the touch screen the touch and a position of the touch on the display screen, and the computing system analyzes the touch, thereby performing the operations.

Here, when the touch sensor panel is disposed separately from the display screen, a display becomes thicker and has a degraded visibility. Accordingly, there is a requirement for overcoming the defects. Also, there is a demand for a method for detecting the touch position and touch pressure at the same time when the touch occurs.

### DISCLOSURE

### Technical Problem

The present invention is designed to consider the above-mentioned problems. An object of the present invention is to provide a display panel capable of sensing a touch position and a touch pressure, a touch input device, a detection device detecting the touch position and the touch pressure from the display panel, and a detection method thereof.

Another object of the present invention is to provide a display panel capable of sensing a touch position and a touch pressure at the same time, a touch input device, a detection device detecting the touch position and the touch pressure from the display panel, and a detection method thereof.

### Technical Solution

One embodiment is a display panel capable of sensing a touch pressure. The display panel includes: a plurality of first electrodes and a plurality of second electrodes which are formed in different layers apart from each other; a plurality of third electrodes formed in the same layer as the layer in which the first electrode is formed; and a reference electrode which is provided between the layer in which the first electrode and the third electrode are formed and the layer in which the second electrode is formed, or provided under the layer in which the first electrode and the third electrode are formed. The plurality of the second electrodes generate a first signal including information on a capacitance which is changed by a touch. The plurality of the third electrodes generate a second signal including information on a capacitance which is changed by the touch.

The plurality of the third electrodes may generate the second signal on the basis of a capacitance change according to a change of a distance between the reference electrode and the third electrode by the touch.

When the reference electrode is formed under the layer in which the first electrode and the third electrode are formed, the layer in which the first electrode and the third electrode are formed may be provided between the layer in which the second electrode is formed and the layer in which the reference electrode is formed.

The reference electrode may include a liquid crystal layer of the display panel.

The display panel may further include a glass layer including a color filter. The plurality of the second electrodes may be formed apart from the layer in which the reference electrode is formed, in such a manner as to have the glass layer placed therebetween.

The plurality of the second electrodes and the plurality of the third electrodes may generate the first signal and the second signal at the same time.

The first signal may be for detecting a position where the touch occurs, and the second signal may be for detecting the touch pressure.

The plurality of the second electrodes may be extended in a direction crossing an extension direction of the first electrode, and the plurality of the third electrodes may be formed not to be overlapped with the plurality of the second electrodes.

The plurality of the first electrodes and the plurality of the third electrodes may use a common electrode included in the display panel.

Another embodiment is a touch input device including:

a display panel including: a plurality of first electrodes and a plurality of second electrodes which are formed in different layers apart from each other; a plurality of third electrodes formed in the same layer as the layer in which the first electrode is formed; and a reference electrode which is provided between the layer in which the first electrode and the third electrode are formed and the layer in which the second electrode is formed, or provided under the layer in which the first electrode and the third electrode are formed;

a driving part which applies a drive signal to the plurality of the first electrodes; and

a detector which receives a first signal including information on a capacitance which is changed by a touch from the plurality of the second electrodes, and receives a second signal including information on a capacitance which is changed by the touch from the plurality of the third electrodes.

The detector may receive the second signal from the plurality of the third electrodes on the basis of the capacitance change according to a change of a distance between the reference electrode and the third electrode by the touch.

When the reference electrode is formed under the layer in which the first electrode and the third electrode are formed, the layer in which the first electrode and the third electrode are formed may be provided between the layer in which the second electrode is formed and the layer in which the reference electrode is formed.

The reference electrode may be provided in a liquid crystal layer of the display panel.

When the touch occurs, the detector may detect not only the first signal from the plurality of the second electrodes but also the second signal from the third electrode.

The first signal may be for detecting a position where the touch occurs, and the second signal may be for detecting the touch pressure.

The plurality of the second electrodes may be extended in a direction crossing a direction in which the plurality of the first electrodes are extended, and the plurality of the third electrodes may be formed not to be overlapped with the plurality of the second electrodes.

The plurality of the first electrodes and the plurality of the third electrodes may use a common electrode included in the display panel.

Further another embodiment is a touch position and touch pressure detection device which detects a touch position signal and a touch pressure signal from a display panel which includes: a plurality of first electrodes and a plurality of second electrodes which are formed in different layers apart from each other; a plurality of third electrodes formed in the same layer as the layer in which the first electrode is formed; and a reference electrode which is provided between the layer in which the first electrode and the third electrode are formed and the layer in which the second electrode is formed, or provided under the layer in which the first electrode and the third electrode are formed. The touch position and touch pressure detection device includes: a driving part which applies a drive signal to the plurality of the first electrodes; and a detector which receives a first signal including information on a capacitance which is changed by a touch from the plurality of the second electrodes, and receives a second signal including information on a capacitance which is changed by the touch from the plurality of the third electrodes.

The plurality of the third electrodes may generate the second signal on the basis of a capacitance change according to a change of a distance between the reference electrode and the third electrode by the touch.

The reference electrode may be provided in a liquid crystal layer of the display panel.

When the touch occurs, the detector may detect not only the first signal from the plurality of the second electrodes but also the second signal from the third electrode.

The plurality of the second electrodes may be extended in a direction crossing a direction in which the plurality of the first electrodes are extended, and the plurality of the third electrodes may be formed not to be overlapped with the plurality of the second electrodes.

### Advantageous Effects

According to the display panel, the detection device detecting the touch position and the touch pressure from the display panel, and the detection method thereof, there is a technical effect that it is not necessary to separately provide the touch sensor because the touch position and the touch pressure can be sensed by the display panel.

According to the display panel, the detection device detecting the touch position and the touch pressure from the display panel, and the detection method thereof, it is possible to simultaneously sense the touch position and the touch pressure instead of to sequentially sense them.

### DESCRIPTION OF DRAWINGS

FIG. 1 is a conceptual view showing a layer structure of a display panel according to an embodiment of the present invention;

FIG. 2 is a block diagram showing a configuration of a touch input device according to the embodiment of the present invention;

FIG. 3 is a block diagram showing a configuration of a detection device according to the embodiment of the present invention;

FIG. 4 is a flowchart for describing a touch position and touch pressure detection method according to the embodiment of the present invention;

FIGS. 5a to 5c are schematic views showing the layer structure of the display panel according to various embodiments of the present invention;

FIGS. 6a to 6c show arrangements of a first electrode T, a second electrode R, and a third electrode C according to the embodiment of the present invention;

FIG. 7 shows an electrode arrangement formed such that the second electrode R and the third electrode C do not overlap each other in the display panel according to the embodiment of the present invention;

FIGS. 8a and 8b are structure views for detecting the touch position and the touch pressure in accordance with the embodiment of the present invention;

FIG. 9 shows a grouped common electrode arrangement according to the embodiment of the present invention.

### BEST MODE

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. The following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, a display panel, a touch input device, a detection device detecting a touch position/a touch pressure from the display panel, and a detection method thereof according to an embodiment of the present invention will be described in detail with reference to the accompanying drawings.

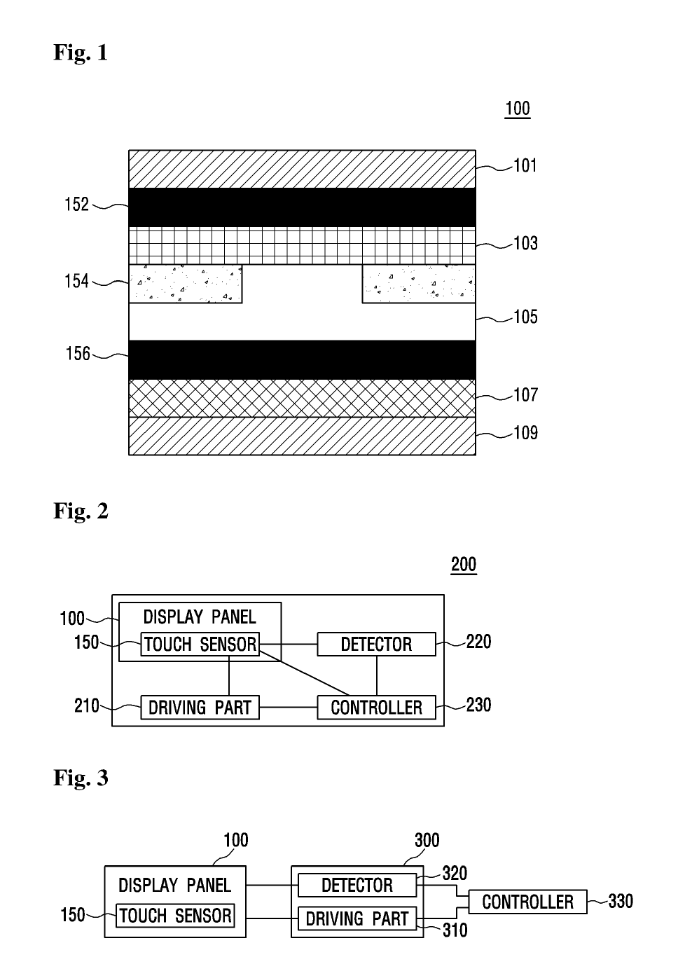

FIG. 1 is a conceptual view showing a layer structure of a display panel 100 according to the embodiment of the present invention. As shown in FIG. 1, the display panel 100 according to the embodiment of the present invention has a stack structure formed by a first polarization layer 101, a second electrode layer 152 having a plurality of second electrodes R formed therein, a first glass layer 103 including a color filter, a liquid crystal layer 105 including a liquid crystal cell, a plurality of reference electrodes 154, a first and third electrode layer 156 having a plurality of first electrodes T and a plurality of third electrodes C formed therein, a second glass layer 107, and a second polarization layer 109.

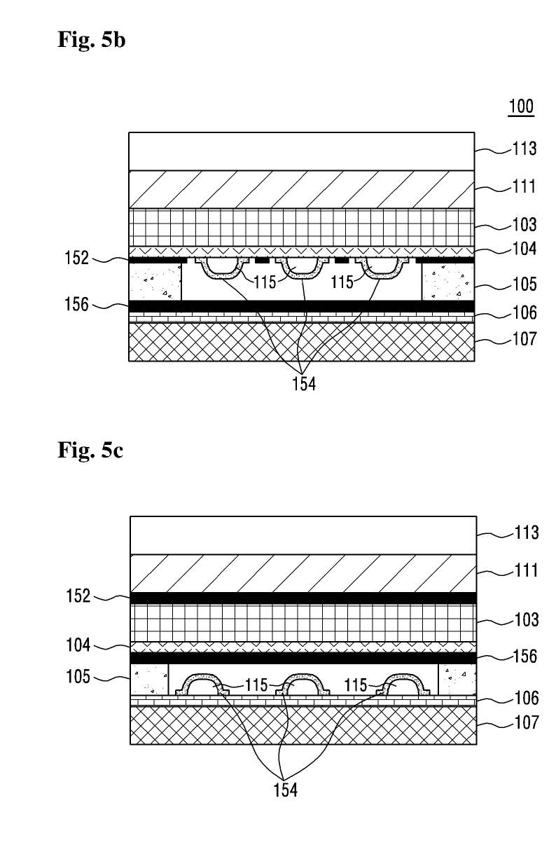

As will be described below, the position of the second electrode layer 152 and the position of the first glass layer 103 including the color filter can be replaced with each other. This will be described later with reference to FIGS. 5a and 5b.

It will be understood by those skilled in the art that the display panel may further include other structures not mentioned above and can be modified, in order to perform a display function.

Also, the display panel 100 according to the embodiment of the present invention shown in FIG. 1 may be included in a liquid crystal display (LCD). Here, the display panel 100 may have any one of a Plane to Line Switching (PLS) type, an In Plane Switching (IPS) type, a Vertical Alignment (VA) type, and a Twisted Nematic (TN) type. Also, the display panel 100 according to the embodiment of the present invention may be included in an organic light emitting diode (OLED), etc.

The plurality of the second electrodes R generate a first signal which has information on a capacitance changing according to the touch and relates to the touch position. Also, the plurality of the third electrodes C generate a second signal which has information on the capacitance changing according to the touch and relates to the touch pressure.

Generally, when an object (a user's finger, a touch pen, etc.) touches the touch surface of the display panel 100, even when a light touch which causes that the display panel 100 is not bent occurs, a mutual capacitance (Cm) between a drive electrode and a receiving electrode. That is, when the object touches the display panel 100, the mutual capacitance (Cm) may be reduced compared to a base mutual capacitance. This is because when the object that acts as a conductor such as a finger or a touch pen approaches the display panel 100, the object functions as ground and fringing capacitance of the mutual capacitance (Cm) is absorbed by the object. When the touch does not occur on the display panel 100, the base mutual capacitance has the same value as the mutual capacitance between the drive electrode and the receiving electrode.

Meanwhile, when a pressure is applied to the touch surface of the display panel 100 by the touch of the object, the display panel 100 is minutely bent. When a reference potential layer (reference electrode) maintains a constant voltage, the mutual capacitance (Cm) between the drive electrode and the receiving electrode may be more reduced. This is because a distance between the reference potential layer and the display panel 100 is reduced due to the bend of the display panel 100, so that the fringing capacitance of the mutual capacitance (Cm) is absorbed by the reference potential layer (reference electrode) as well as by the object. When the touch object is a nonconductor, the change of the mutual capacitance (Cm) may simply result from the change of the distance between the reference potential layer (reference electrode) and the touch sensor. When the distance becomes smaller in a case where the reference potential layer is a floating node, the mutual capacitance (Cm) is increased conversely. In other words, a total mutual capacitance (Cm) is also increased because the capacitance between the reference potential layer and the first electrode and the capacitance between the reference potential layer and the third electrode are increased, and the capacitance between the reference potential layer and the first electrode, which occupies a certain portion of the mutual capacitance (Cm) between the first electrode and the third electrode, and a series capacitance of the capacitance between the reference potential layer and the third electrode is also increased. Therefore, the total mutual capacitance (Cm) is also increased.

Here, the touch surface of the display panel 100 is the outer surface of the display panel 100 and may be the top surface or bottom surface in FIG. 1. Here, though not shown in FIG. 1, the top surface or bottom surface of the display panel 100 may be covered with a cover glass (reference numeral 113 of FIGS. 5a and 5b) such as glass.

Referring back to FIG. 1, the liquid crystal layer 105 includes the reference electrode 154. The first and third electrode layer 156 is formed in contact with the liquid crystal layer 105. The mutual capacitance (Cm) is formed between the plurality of the first electrodes T and the plurality of the third electrodes C which are included in the first and third electrode layer 156.

The reference electrode 154 within the liquid crystal layer 105 may be spaced apart from the first and third electrode layer 156. The reference electrode 154 may be formed by forming a conductive material layer on a part or the entire of a spacer 170 included in the liquid crystal layer 105. This will be described below in more detail. The first and third electrode layer 156 may be, as shown in the embodiment of FIG. 1, formed on the layer in which the reference electrode 154 is included, or according to the embodiment, may be formed under the layer in which the reference electrode 154 is included. This will be described later with reference to FIGS. 5a to 5c showing various layer structures of the display panel 100 according to the embodiment of the present invention.

In a case where the first and third electrode layer 156 is formed under the layer in which the reference electrode 154 is included, when a pressure is applied to the touch surface of the display panel 100 by the touch of the object, the reference electrode 154 moves downward, the reference electrode 154 becomes closer to the first and third electrode layer 156. Therefore, the mutual capacitance (Cm) between the first electrode T and the third electrode C is changed (reduced). However, when the reference electrode 154 is a floating node, the mutual capacitance (Cm) between the first electrode T and the third electrode C may be increased.

Also, when the object touches the touch surface of the display panel 100, the mutual capacitance (Cm) between the first electrode T included in the first and third electrode layer 156 and the second electrode R included in the second electrode layer 152 is reduced.

Likewise, in a case where the first and third electrode layer 156 is formed on the layer in which the reference electrode 154 is included, when a pressure is applied to the touch surface of the display panel 100 by the touch of the object, the first and third electrode layer 156 moves downward, the first and third electrode layer 156 becomes closer to the reference electrode 154. Therefore, the mutual capacitance (Cm) between the first electrode T and the third electrode C is changed (reduced). However, when the reference electrode 154 is a floating node, the mutual capacitance (Cm) between the first electrode T and the third electrode C may be, as described above, increased.

Also, when the object touches the touch surface of the display panel 100, the mutual capacitance (Cm) between the first electrode T included in the first and third electrode layer 156 and the second electrode R included in the second electrode layer 152 is reduced.

On the basis of the change of the mutual capacitance (Cm), the first signal and the second signal which are able to detect the touch position and the touch pressure. Also, the second electrode R and the third electrode C are disposed in different layers, so that the first signal and the second signal can be generated at the same time.

However, in another embodiment, the pressure may be detected by the change of a self-capacitance (Cs) according to the distance between the first electrode T and the reference electrode 154. That is, the pressure may be detected by the change of the self-capacitance (Cs) between the first electrode T and the reference electrode 154 or between the third electrode C and the reference electrode 154.

It is desirable that the plurality of the first electrodes, the plurality of the second electrodes, and the plurality of the third electrodes should be made of a transparent conductive material (e.g., Indium Tin Oxide (ITO) or Antimony Tin Oxide (ATO) made of SnO₂ and In₂O₃, etc.), or the like.

FIG. 2 is a block diagram showing a configuration of a touch input device 200 according to the embodiment of the present invention. As shown in FIG. 2, the touch input device 200 according to the embodiment of the present invention includes the display panel 100 including a touch sensor 150, a driving part 210, and a detector 220. FIG. 2 shows that a controller 230 is included in the touch input device 200 according to the embodiment of the present invention. However, unlike this, the controller 230 may be provided separately from the touch input device 200 according to the embodiment of the present invention, or the driving part 210 and the detector 220 may have a below-described function of the controller 230.

The structure of the display panel 100 has been described in detail with reference to FIG. 1, and will be omitted here. Also, the touch sensor 150 included in the display panel 100 includes the first and third electrode layer 156, the second electrode layer 152, the liquid crystal layer 105 including the reference electrode 154, which are directly involved in the touch position and the touch pressure. Further, the touch sensor 150 may also include other structures.

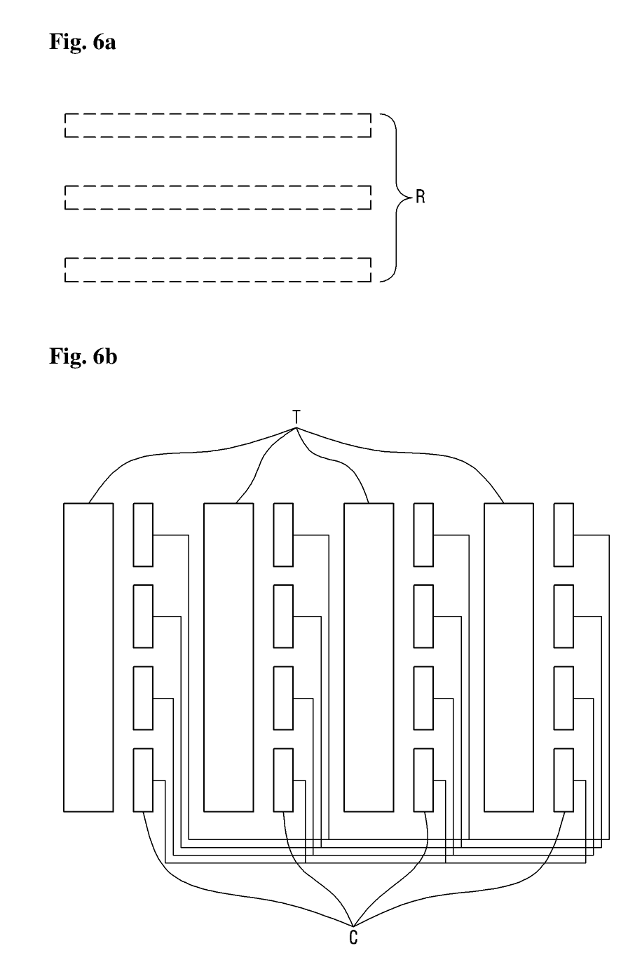

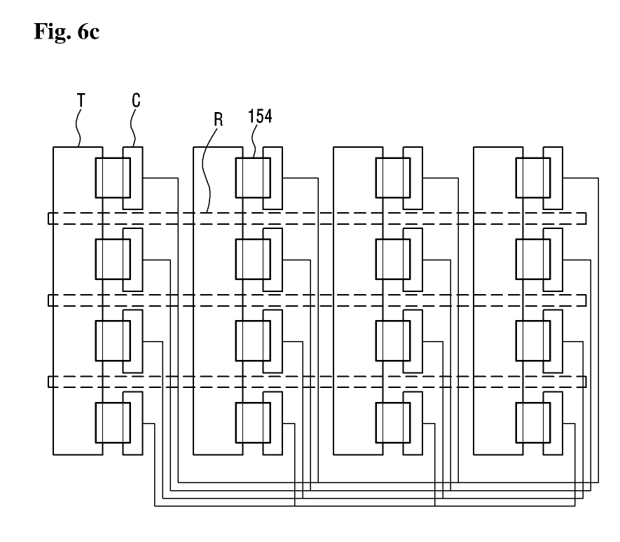

The first electrode T is formed in the same layer (first and third electrode layer 156) as that in which the third electrode C is formed. Also, as shown in FIG. 6b, the plurality of the third electrodes C may be disposed apart from each other in a direction in which the first electrode T is extended. Meanwhile, the plurality of the second electrodes R may be extended in a direction crossing the first electrode T. That is, the plurality of the first electrodes T and the plurality of the second electrodes R may form an orthogonal array.

However, the present invention is not limited to this. The plurality of the first electrodes T and the plurality of the second electrodes R may have an array of arbitrary dimension, for example, a diagonal array, a concentric array, a 3-dimensional random array, etc., and an array obtained by the application of them.

The driving part 210 may apply a drive signal to the plurality of the first electrodes T included in the first and third electrode layer 156. In the embodiment of the present invention, the driving part 210 may sequentially apply the drive signal to the plurality of the first electrodes T of the touch sensor 150 formed within the display panel 100. The application of the drive signal can be repeatedly performed. However, in another embodiment, the driving part 210 may simultaneously apply the drive signal to the plurality of the first electrodes T.

Through the second electrode R included in the second electrode layer 152, the detector 220 receives a sensing signal (first signal) including information on the mutual capacitance (Cm) between the second electrode R and the first electrode T to which the drive signal has been applied, thereby detecting whether or not the touch occurs and touch position. For example, the sensing signal (first signal) may be a signal coupled by the mutual capacitance (Cm) formed between the second electrode R and the first electrode T to which the drive signal has been applied.

Through the plurality of the third electrodes C included in the first and third electrode layer 156, the detector 220 receives a sensing signal (second signal) including information on the mutual capacitance (Cm) between the reference electrode 154 and the third electrode C and the first electrode T to which the drive signal has been applied, thereby detecting the touch pressure.

The detector 220 may include a receiver (not shown) connected to the second electrode R of the second electrode layer 152, which is the receiving electrode, and to the third electrode C of the first and third electrode layer 156, which is the receiving electrode, through a switch. The switch becomes the on-state in a time interval during which the signal of the receiving electrode is sensed. Here, the receiver is able to sense the sensing signal from the receiving electrode. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The negative input terminal of the amplifier is connected to the receiving electrode and receives and integrates the first signal including information on the mutual capacitance (Cm) and the second signal including information on the mutual capacitance (Cm), and then converts the first and second integrated signals into voltage. The detector 220 may further include an analog-digital converter (ADC) (not shown) which converts the integrated data by the receiver into digital data. Later, the digital data may be input to a processor (not shown) and processed to obtain touch position information and touch pressure information on the display panel 100. The detector 200 may include the ADC and processor as well as the receiver.

The controller 230 may perform a function of controlling the operations of the driving part 210 and the detector 220. As mentioned above, the controller 230 can be provided separately from the touch input device 200 according to the embodiment of the present invention.

The controller 230 generates and transmits a drive control signal to the driving part 210, thereby causing the driving part 210 to apply the drive signal to the predetermined first electrode T at a predetermined time. Also, the controller 230 generates and transmits a detection control signal to the detector 220, thereby causing the detector 220 to receive the first signal and the second signal from the second predetermined electrode R and the third predetermined electrode C and to perform a predetermined function.

FIG. 3 is a block diagram showing a configuration of a touch position and touch pressure detection device 300 according to the embodiment of the present invention. The detection device 300 according to the embodiment includes a driving part 310 and a detector 320. Particularly, the detection device 300 according to the embodiment detects a touch position signal and a touch pressure signal from the display panel in accordance with the embodiment of the present invention shown in FIG. 1.

Since the operations of the driving part 310 and the detector 320 have been described in detail with reference to FIG. 2, the description thereof will be omitted. Also, since the operation of the controller 330 has been described above, the description thereof will be omitted. Also, according to the embodiment, the controller 330 may be included in the touch position and touch pressure detection device 300.

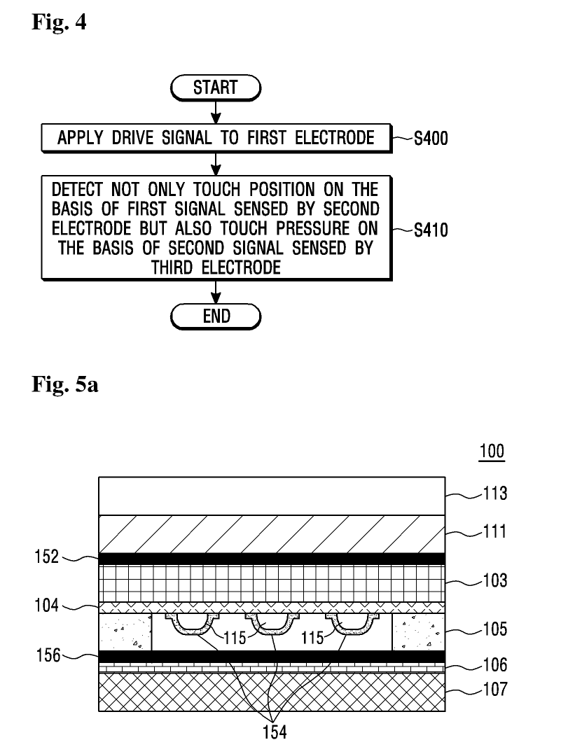

FIG. 4 is a flowchart for describing a touch position and touch pressure detection method according to the embodiment of the present invention. As shown in FIG. 4, first, the touch position and touch pressure detection method according to the embodiment includes applying the drive signal to the first electrode T (S400).

Then, the detection method includes detecting, in response to the drive signal applied to the first electrode T, the touch position on the basis of the first signal having information on the capacitance which is changed by the touch, which is sensed by the plurality of the second electrodes R, and simultaneously with this, detecting the touch pressure on the basis of the second signal having information on the capacitance which is changed by the touch, which is sensed by the plurality of the third electrodes C (S410).

In other words, in the step S410, the touch position detection based on the first signal sensed by the plurality of the second electrodes R included in the second electrode layer 152 and the touch pressure detection based on the second signal sensed by the plurality of the third electrodes C included in the first and third electrode layer 156 are performed at the same time. Since the second electrode R and the third electrode C are located in the separate layers such that the liquid crystal layer 105 including the reference electrode 154 is placed between the second electrode R and the third electrode C, the first signal and the second signal can be sensed at the same time, and the touch position and the touch pressure can be detected based on the signals at the same time.

The touch position and touch pressure detection method according to the embodiment of the present invention shown in FIG. 4 will be described in more detail. First, the step S400 is performed, so that the drive signal is applied to the first electrode T.

Here, when the object touches the touch surface of the display panel 100, the mutual capacitance (Cm) between the plurality of the first electrodes T included in the first and third electrode layer 156 and the plurality of the second electrodes R included in the second electrode layer 152 is reduced. The plurality of the second electrodes R included in the second electrode layer 152 generate the first signal, i.e., the touch position signal, including the information on the capacitance which is changed by the touch.

Simultaneously with this, when a pressure is applied to the touch surface of the display panel 100 by the touch of the object, the reference electrode 154 moves toward the second glass layer 107, and thus, becomes closer to the first and third electrode layer 156, or alternatively the first and third electrode layer 156 moves toward the second glass layer 107, and thus, becomes closer to the reference electrode 154. Therefore, the mutual capacitance (Cm) between the first electrode T and the third electrode C is changed (decreased or increased). The plurality of the third electrodes C included in the first and third electrode layer 156 generate the second signal, i.e., the touch pressure signal, including the information on the capacitance which is changed by the touch.

As described above, the first signal and the second signal are generated at the same time. Therefore, in response to the drive signal applied to the plurality of the first electrodes T, the touch position is detected on the basis of the first signal sensed by the plurality of the second electrodes R, and simultaneously with this, the touch pressure is detected on the basis of the second signal sensed by the plurality of the third electrodes C.

FIGS. 5a to 5b are schematic views showing the structure of the display panel 100 according to various embodiments of the present invention.

As with FIG. 1, in the display panel 100 according to the embodiment of FIG. 5a, the second electrode layer 152 is disposed on the first glass layer 103. For the purpose of making the structure of the display panel 100 of the present invention more clear, FIG. 5a further shows an uppermost cover glass layer 113 and an optically clear adhesive (OCA) layer 111 for adhering the same, shows a color filter layer 104 separately from the first glass layer 103, and shows a TFT layer 106 separately from the second glass layer 107. In the present description, the touch surface of the display panel 100 may be the cover glass layer 113 shown in FIG. 5a.

Meanwhile, it is desirable that the reference electrode 154 included in the liquid crystal layer 105 of the display panel 100 shown in FIG. 5a should be, as shown, formed apart from the first and third electrode layer 156. Here, the reference electrode 154 does not necessarily have to be formed on the top surface of the crystal liquid layer 105 shown in FIG. 5a if the reference electrode 154 is formed at a position where the distance between the reference electrode 154 and the first and the third electrode layers 156 is changed as bending occurs by the touch on the surface of the display panel 100.

The spacer for obtaining a space may be provided in the liquid crystal layer 105 of the display panel 100. The spacer may be formed within the liquid crystal layer 105 or may be formed on a layer located on the liquid crystal layer 105. In the embodiment of the present invention, the reference electrode 154 may be formed by forming a conductive material such as ITO on the spacer.

In another embodiment, the reference electrode 154 may be formed by forming the conductive material on a part of the spacer instead of the entire of the spacer. Separately from the spacer, the conductive material-made reference electrode 154 may be formed. That is, the reference electrode 154 may be provided by any method as long as the reference electrode 154 is spaced from the first and third electrode layer 156 and is able to function as an electrode capable of changing the mutual capacitance (Cm).

FIG. 5b shows the layer structure of the display panel 100 according to another embodiment of the present invention. Unlike FIG. 5a, in the embodiment, the second electrode layer 152 including the plurality of the second electrodes R is formed in contact with the liquid crystal layer 105. Since other structures have been described in the description related to FIG. 5a, the description thereof will be omitted.

FIGS. 5a and 5b show various embodiments in which the first and third electrode layer 156 and the second electrode layer 152 are spaced from each other such that the liquid crystal layer 105 including the reference electrode 154 is placed between the first and third electrode layer 156 and the second electrode layer 152. As long as the first and third electrode layer 156 and the second electrode layer 152 are spaced from each other such that the liquid crystal layer 105 including the reference electrode 154 is placed between the first and third electrode layer 156 and the second electrode layer 152, it can be considered that the second electrode layer 152 or the first and third electrode layer 156 is formed differently from what is shown in FIG. 5a or 5b.

Meanwhile, unlike FIG. 5a or 5b, FIG. 5c shows a layer structure in which the reference electrode 154 is formed under the first and third electrode layer 156.

As shown in FIG. 5c, the reference electrode 154 of the display panel 100 is spaced apart from and formed under the first and third electrode layer 156. Here, the reference electrode 154 can be formed at any position within the crystal liquid layer 105 if the reference electrode 154 is formed at a position where the distance between the reference electrode 154 and the first and the third electrode layers 156 is changed as bending occurs by the touch on the surface of the display panel 100.

Also in the embodiment of FIG. 5c, a spacer 115 for obtaining a space may be provided in the liquid crystal layer 105 of the display panel 100. The reference electrode 154 may be formed under the first and third electrode layer 156 and may be formed by forming a conductive material such as ITO on the spacer 115. The reference electrode 154 may be also formed by forming the conductive material on a part of the spacer 115 instead of the entire of the spacer 115.

Also, separately from the spacer 115, the conductive material-made reference electrode 154 may be formed. That is, the reference electrode 154 may be provided by any method as long as the reference electrode 154 is spaced downwardly from the first and third electrode layer 156 and is able to function as an electrode capable of changing the mutual capacitance (Cm).

Based on the structures of FIGS. 5a to 5c, the embodiment of the present invention can be applied to various types of liquid crystal displays. That is, the embodiment of the present invention can be applied to the liquid crystal display having the structure in which the first and third electrode layer 156 is located on the liquid crystal layer 105, or can be also applied to the liquid crystal display having the structure in which the first and third electrode layer 156 is located under the liquid crystal layer 105.

More specifically, the display panel 100 according to the embodiments of FIGS. 5a and 5b can be applied to a PLS type or IPS type liquid crystal display in which a common electrode is located under the liquid crystal layer.

The PLS type liquid crystal display is advantageous in that it has an excellent side visibility and an excellent transmittance and has a rapid response speed and low power consumption. Also, the IPS type liquid crystal display is advantageous in that it has an excellent side visibility and a rapid response speed.

The display panel 100 according to the embodiment of FIG. 5c can be applied to a VA type or TN type liquid crystal display in which the common electrode is located on the liquid crystal layer.

The VA type liquid crystal display is advantageous in that it has an excellent contrast ratio. The TN type liquid crystal display is advantageous in terms of a material cost, process, and transmittance, and also has a rapid response speed and low power consumption.

As such, the layer structures of the display panel 100 according to the embodiments of FIGS. 5a to 5c can be applied to various type of liquid crystal displays in accordance with required characteristics. Since the structure and principle of each type correspond to the publicly known art in the technical field to which the present invention belongs, the detailed description thereof will be omitted.

FIGS. 6a to 6c show arrangements of the first electrode T, the second electrode R, and the third electrode C which are included in the display panel 100 according to the embodiment of the present invention.

As shown in FIG. 6a, the plurality of the second electrodes R included in the second electrode layer 152 may be extended in a certain direction and be disposed in parallel with each other by an interval. For convenience of description, FIG. 6a shows only the three second electrodes R. However, a smaller or greater number of the second electrodes R may be provided.

Meanwhile, as shown in FIG. 6b, the plurality of the first electrodes T included in the first and third electrode layer 156 may be extended in a direction crossing the extension direction of the plurality of the second electrodes R and may be disposed in parallel with each other.

The plurality of the third electrodes C included in the first and third electrode layer 156 are disposed apart from the first electrode T by an interval. Although FIG. 6b shows that the four first electrodes T and the sixteen third electrodes C are provided, it is obvious that a smaller or greater number of the first electrodes T and a smaller or greater number of the third electrodes C may be provided.

FIG. 6c shows the first and third electrode layer 156 of FIG. 6b as well as the second electrode layer 152 of FIG. 6a. As shown in FIG. 6c, the plurality of the second electrodes R included in the second electrode layer 152 may be disposed not to be overlapped with the plurality of the third electrodes C included in the third electrode layer 156. As such, the second electrode R and the third electrode C, which are receiving electrodes, are disposed not to be overlapped with each other, so that mutual interference is reduced, and thus, sensitivity is more improved in sensing the first signal and the second signal.

Meanwhile, although FIG. 6c shows that the reference electrode 154 is located on the first and third electrode layer 156, it is possible that the reference electrode 154 is, as shown in FIG. 5c, located under the first and third electrode layer 156.

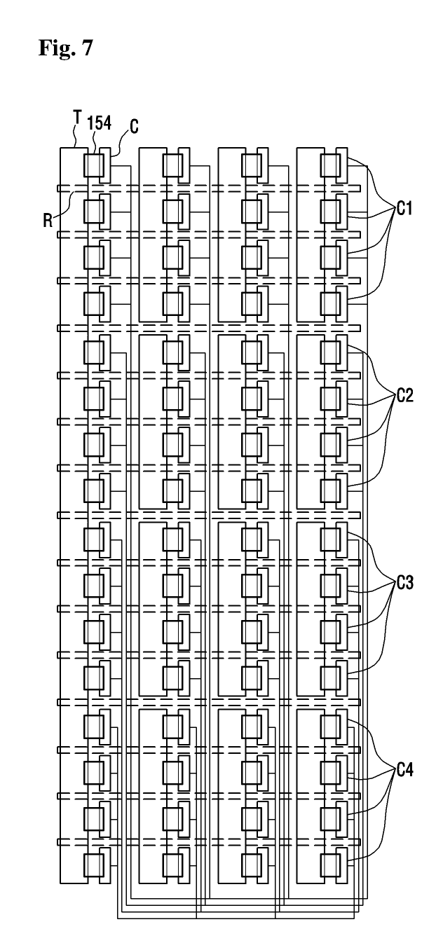

FIG. 7 shows an electrode arrangement formed such that the plurality of the second electrodes R and the plurality of the third electrodes C do not overlap each other in the display panel 100 according to the embodiment of the present invention. The number of the second electrodes R may be greater than the number of the third electrodes C. In this case, in order that the plurality of the second electrodes R and the plurality of the third electrodes C do not overlap each other, each of the plurality of the third electrodes C may be configured in a split form.

In other words, as shown in FIG. 7, the plurality of the third electrodes C-1, C-2, C-3, and C-4 may be split into four lower electrodes respectively. The plurality of the second electrodes R of the second electrode layer 152 pass through the areas formed by spacing the lower electrodes split from the first and third electrode layer 156, so that the third electrode C and the second electrode R can avoid overlapping each other.

Also, the split lower electrodes are connected by the same wiring, so that the lower electrodes can operate in the same manner as the non-split third electrode C of FIG. 6c but also the wiring structure is not significantly changed. Specifically, this can be implemented in such a manner that the third electrode C-1 split into four lower electrodes is connected by one wiring, and the third electrode C-2 split into four lower electrodes is connected by one wiring, and then the third electrode C-3 split into four lower electrodes is connected by one wiring.

FIG. 7 shows a case where the plurality of the third electrodes C are split into four lower electrodes respectively. However, unlike this, it is also possible that the plurality of the third electrodes C are split into a smaller or greater number of the lower electrodes.

Meanwhile, in another embodiment, unlike FIG. 6c or 7, it is possible to assume that the plurality of the second electrodes R are formed to be overlapped with the third electrode C.

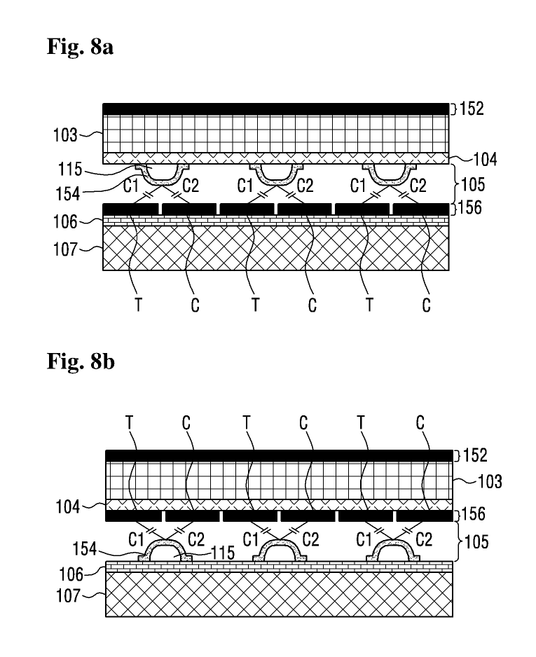

FIGS. 8a and 8b are structure views for detecting the touch position and the touch pressure in accordance with the embodiment of the present invention. As shown in FIG. 8a, the TFT layer 106 is formed on the second glass layer 107 of the display panel 100 according to the embodiment of the present invention. The TFT layer 206 includes electrical components necessary to generate an electric field for driving the liquid crystal layer 105.

In particular, the TFT layer 106 may be composed of various layers including a data line a gate line, TFT, a common electrode, and a pixel electrode, etc. These electrical components may operate in such a manner as to generate a controlled electric field and orient liquid crystals located in the liquid crystal layer 105.

In the display panel 100, the touch input device 200, and the touch position and touch pressure detection device 300 according to the embodiment of the present invention, the plurality of the first electrodes and the plurality of the third electrodes may use a common electrode included in the display panel.

As shown in FIG. 8a, in the display panel 100 according to the embodiment of the present invention, a conductive material such as ITO is formed on the spacer 115 located on the first and third electrode layer 156 and is used as the reference electrode 154. Although it has been described that the spacer 115 is included in the liquid crystal layer 105, the spacer 115 may be also formed in the first glass layer 103 including the color filter layer 104. Here, the fringing capacitance (C1) related to the touch pressure signal may be formed between the reference electrode 154 and the plurality of the first electrodes T that use the common electrode, and the fringing capacitance (C2) related to the touch pressure signal may be formed between the reference electrode 154 and the plurality of the third electrodes C that use the common electrode.

As shown in FIG. 8a, in the display panel 100 according to the embodiment of the present invention, when a pressure is applied to the touch surface of the display panel 100 by the touch of the object, a distance between the reference electrode 154 and the TFT layer 106 is reduced, and thus, a distance between the reference electrode 154 and the plurality of the third electrodes C and the plurality of the first electrodes T which are composed of low common electrode is reduced, so that the mutual capacitance (Cm) is changed (decreased or increased). Accordingly, the touch pressure can be detected by the generated second signal.

In the embodiment of FIG. 8a, it is shown that the second electrode layer 152 is formed on the first glass layer 103. However, it is possible that the second electrode layer 152 is, as shown in FIG. 5b, formed under the color filter layer 104.

As shown in FIG. 8b, in the display panel 100 according to the embodiment of the present invention, a conductive material such as ITO is formed on the spacer 115 located under the first and third electrode layer 156 and is used as the reference electrode 154.

Here, the first and third electrode layer 156 may use the common electrode located on the liquid crystal layer 105. Although it has been described that the spacer 115 is included in the liquid crystal layer 105, the spacer 115 may be also formed on the TFT layer 106 including the pixel electrode.

Here, the fringing capacitance (C1) related to the touch pressure signal may be formed between the reference electrode 154 and the plurality of the first electrodes T that use the common electrode, and the fringing capacitance (C2) related to the touch pressure signal may be formed between the reference electrode 154 and the plurality of the third electrodes C that use the common electrode.

As shown in FIG. 8a, in the display panel 100 according to the embodiment of the present invention, when a pressure is applied to the touch surface of the display panel 100 by the touch of the object, the plurality of the third electrodes C and the plurality of the first electrodes T which are composed of the common electrode move toward the reference electrode 154, and thus, the distance between the reference electrode 154 and the plurality of the first electrodes T and the plurality of the third electrodes C is reduced. Therefore, the mutual capacitance (Cm) is changed (decreased or increased). Accordingly, the touch pressure can be detected by the generated second signal.

Meanwhile, in FIGS. 8a and 8b, when the reference electrode 154 is a floating node, the first electrode T and the third electrode C become closer to the reference electrode 154, and then the mutual capacitance (Cm) may be increased. That is, the capacitance (C1) between the reference electrode 154 and the first electrode T is increased and the capacitance (C2) between the reference electrode 154 and the third electrode C is increased. Also, the series capacitance of the capacitance (C1 and C2), which occupies a certain portion of the mutual capacitance (Cm) between the first electrode T and the third electrode C, is also increased. Therefore, the total mutual capacitance (Cm) is also increased.

Based on the structures of FIGS. 8a and 8b, the embodiment of the present invention can be applied to any types of liquid crystal displays. That is, the embodiment of the present invention can be applied to the liquid crystal display having the structure in which the common electrode is located on the liquid crystal layer 105, or can be also applied to the liquid crystal display having the structure in which the common electrode is located under the liquid crystal layer 105.

More specifically, the display panel 100 according to the embodiment of FIG. 8a can be applied to a PLS type or IPS type liquid crystal display in which the common electrode is located under the liquid crystal layer. The display panel 100 according to the embodiment of FIG. 8b can be applied to a VA type or TN type liquid crystal display in which the common electrode is located on the liquid crystal layer.

Each type of the liquid crystal display is advantageous in terms of a side visibility, transmittance, contrast ratio, response speed, power consumption, etc. Therefore, in accordance with required product characteristics, the display panel 100 according to the embodiment of the present invention can be applied to various types of the liquid crystal displays.

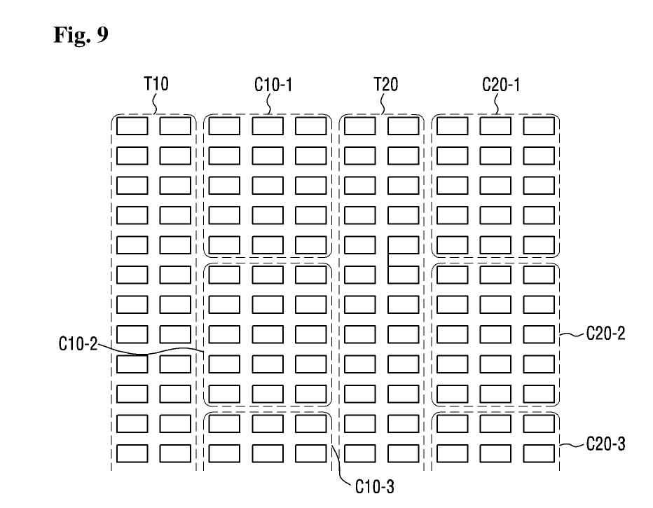

FIG. 9 shows a grouped common electrode arrangement according to the embodiment of the present invention. As shown in FIG. 9, a plurality of the common electrodes may be arranged at a regular interval in a checkerboard shape. Here, the common electrodes can be grouped as indicated by dotted lines in FIG. 9. By being grouped as above, the plurality of the common electrodes are able to function as the first electrode T and the third electrode C.

Although FIG. 9 shows that the plurality of the common electrodes are grouped into the two first electrodes T10 and T20 and the six third electrodes C10-1, C10-2, C10-3, C20-1, C20-2, and C20-3, the number of the grouped first electrodes T and the number of the grouped third electrodes C may be different from the numbers shown in FIG. 9. Besides, a smaller or greater number of the common electrodes may be grouped, and the grouped first electrodes T and the grouped third electrodes C may have various shapes.

The display panels 100 shown in FIGS. 8a, 8b, and 9 are able to function as the display panel 100 by causing the electrical components of the display panel 100 to operate in conformity with their original purposes. Also, the display panel 100 is able to function as a touch pressure sensing module by causing at least a portion of the electrical components of the display panel 100 to operate for sensing the touch pressure and position. Here, each of the operation modes can be performed in a time-division manner That is, the display panel 100 may function as the display module in a first time interval, and the display panel 100 may function as the touch pressure and/or touch position sensing (or input) device in a second time interval.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

1. A display panel capable of sensing a touch pressure, the display panel comprising:
a plurality of first electrodes and a plurality of second electrodes which are formed in different layers apart from each other;
a plurality of third electrodes formed in the same layer as the layer in which the first electrode is formed; and
a reference electrode which is provided between the layer in which the first electrode and the third electrode are formed and the layer in which the second electrode is formed, or provided under the layer in which the first electrode and the third electrode are formed,
wherein the plurality of the second electrodes generate a first signal including information on a capacitance which is changed by a touch, and the plurality of the third electrodes generate a second signal including information on a capacitance which is changed by the touch.

2. The display panel of claim 1, wherein the plurality of the third electrodes generates the second signal on the basis of a capacitance change according to a change of a distance between the reference electrode and the plurality of the third electrodes by the touch.

3. The display panel of claim 1, wherein, when the reference electrode is formed under the layer in which the first electrode and the third electrode are formed, the layer in which the first electrode and the third electrode are formed is provided between the layer in which the second electrode is formed and the layer in which the reference electrode is formed.

4. The display panel of claim 1, wherein the reference electrode is provided in a liquid crystal layer of the display panel.

5. The display panel of claim 1, further comprising a glass layer comprising a color filter, wherein the plurality of the second electrodes are formed apart from the layer in which the reference electrode is formed, in such a manner as to have the glass layer placed therebetween.

6. The display panel of claim 1, wherein the plurality of the second electrodes and the plurality of the third electrodes generate the first signal and the second signal at the same time.

7. The display panel of claim 1, wherein the first signal is for detecting a position where the touch occurs, and wherein the second signal is for detecting the touch pressure.

8. The display panel of claim 1, wherein the plurality of the second electrodes are extended in a direction crossing an extension direction of the first electrode, and wherein the plurality of the third electrodes are formed not to be overlapped with the plurality of the second electrodes.

9. The display panel of claim 1, wherein the plurality of the first electrodes and the plurality of the third electrodes use a common electrode included in the display panel.

10. A touch input device comprising:
a display panel comprising:
a plurality of first electrodes and a plurality of second electrodes which are formed in different layers apart from each other;
a plurality of third electrodes formed in the same layer as the layer in which the first electrode is formed; and
a reference electrode which is provided between the layer in which the first electrode and the third electrode are formed and the layer in which the second electrode is formed, or provided under the layer in which the first electrode and the third electrode are formed;
a driving part which applies a drive signal to the plurality of the first electrodes; and
a detector which receives a first signal including information on a capacitance which is changed by a touch from the plurality of the second electrodes, and receives a second signal including information on a capacitance which is changed by the touch from the plurality of the third electrodes.

11. The touch input device of claim 10, wherein the detector receives the second signal from the plurality of the third electrodes on the basis of the capacitance change according to a change of a distance between the reference electrode and the plurality of the third electrodes by the touch.

12. The touch input device of claim 10, wherein, when the reference electrode is formed under the layer in which the first electrode and the third electrode are formed, the layer in which the first electrode and the third electrode are formed is provided between the layer in which the second electrode is formed and the layer in which the reference electrode is formed.

13. The touch input device of claim 10, wherein the reference electrode is provided in a liquid crystal layer of the display panel.

14. The touch input device of claim 10, wherein, when the touch occurs, the detector detects not only the first signal from the plurality of the second electrodes but also the second signal from the third electrode.

15. The touch input device of claim 10, wherein the first signal is for detecting a position where the touch occurs, and wherein the second signal is for detecting the touch pressure.

16. The touch input device of claim 10, wherein the plurality of the second electrodes are extended in a direction crossing a direction in which the plurality of the first electrodes are extended, and wherein the plurality of the third electrodes are formed not to be overlapped with the plurality of the second electrodes.

17. The touch input device of claim 10, wherein the plurality of the first electrodes and the plurality of the third electrodes use a common electrode included in the display panel.

18. A touch position and touch pressure detection device which detects a touch position signal and a touch pressure signal from a display panel which comprises:
a plurality of first electrodes and a plurality of second electrodes which are formed in different layers apart from each other;
a plurality of third electrodes formed in the same layer as the layer in which the first electrode is formed; and
a reference electrode which is provided between the layer in which the first electrode and the third electrode are formed and the layer in which the second electrode is formed, or provided under the layer in which the first electrode and the third electrode are formed,
the touch position and touch pressure detection device comprising:
a driving part which applies a drive signal to the plurality of the first electrodes; and
a detector which receives a first signal including information on a capacitance which is changed by a touch from the plurality of the second electrodes, and receives a second signal including information on a capacitance which is changed by the touch from the plurality of the third electrodes.

19. The touch position and touch pressure detection device of claim 18, wherein the plurality of the third electrodes generates the second signal on the basis of a capacitance change according to a change of a distance between the reference electrode and the plurality of the third electrodes by the touch.

20. The touch position and touch pressure detection device of claim 18, wherein the reference electrode is provided in a liquid crystal layer of the display panel.

21. The touch position and touch pressure detection device of claim 18, wherein, when the touch occurs, the detector detects not only the first signal from the plurality of the second electrodes but also the second signal from the third electrode.

22. The touch position and touch pressure detection device of claim 18, wherein the plurality of the second electrodes are extended in a direction crossing a direction in which the plurality of the first electrodes are extended, and wherein the plurality of the third electrodes are formed not to be overlapped with the plurality of the second electrodes.
